(19) United States
(12) Patent Application Publication
(10) Pub. No.: US 2026/0338258 A1
(43) Pub. Date: Oct. 29, 2026

(54) Oscillating Tooth Speed Reducer

(71) Applicant: Ningbo Zaisu Technology Co., Ltd., Cixi City (CN)

(72) Inventors: Zhongyin Wang, Cixi City (CN); Lian Fu, Cixi City (CN); Xuesheng Wang, Cixi City (CN)

(21) Appl. No.: 19/440,766

(22) Filed: Jan. 6, 2026

(30) Foreign Application Priority Data
Apr. 25, 2025 (CN) 202520799114.0

(51) Int. Cl. F16H 1/32

(52) U.S. Cl. CPC F16H 1/32; F16H 2001/323

(57) ABSTRACT

The present application provides an oscillating tooth speed reducer, including a crossed roller bearing to bear radial and axial loads and an oscillating tooth transmission mechanism to perform a speed-reducing function; wherein the oscillating tooth transmission mechanism includes an input end cam, an oscillating tooth spacer, an oscillating tooth provided in a plurality of uniformly arranged oscillating tooth grooves of the oscillating tooth spacer and an inner gear ring for being engaged with the oscillating tooth; one side of the oscillating tooth is rollingly connected to the input end cam; the other side of the oscillating tooth is engaged with the inner gear ring for performing a tangential motion with the internal gear profile to drive the oscillating tooth spacer to perform rotary motion. The present application is a transmission mechanism with a less tooth difference, with good rigidity, a long service life and a low maintenance cost.

### DESCRIPTION

### Technical Field

The present utility model relates to the technical field of speed reducers, and particularly relates to an oscillating tooth speed reducer which can bear an axial or radial load.

### Background Art

The cycloidal speed reducer used in the prior art, which is made of a combination of a crankshaft and an eccentric bearing, is not only complicated in structure and difficult to manufacture, but also large in volume and weight. With the increasing demands of robot industry, there is more and more demand for miniaturized cycloidal speed reducers, but the cycloidal speed reducers in the prior art cannot be miniaturized due to the use of crankshaft.

In order to solve this problem, there is still room for improvement in the speed reducer in the prior art.

### Summary of the Invention

In view of the above-mentioned defects, the present utility model is directed to provide a high-precision, high-efficiency oscillating tooth speed reducer which can bear an axial or radial load, which retains the advantages of the cycloid speed reducer of the prior art, and is simple in structure and small in size for manufacturing so as to solve the problems of the prior art.

In order to achieve the above-mentioned object, the present utility model adopts the following technical solutions.

An oscillating tooth speed reducer includes a crossed roller bearing to bear radial and axial loads and an oscillating tooth transmission mechanism to perform a speed-reducing function; wherein the oscillating tooth transmission mechanism includes an input end cam, an oscillating tooth spacer, an oscillating tooth provided in a plurality of uniformly arranged oscillating tooth grooves of the oscillating tooth spacer and an inner gear ring for being engaged with the oscillating tooth; one side of the oscillating tooth is rollingly connected to the input end cam for an input piece of the transmission mechanism; the other side of the oscillating tooth is engaged with the inner gear ring for performing a tangential motion with the internal gear profile to drive the oscillating tooth spacer to perform rotary motion; the crossed roller bearing includes a crossed roller bearing outer race, a roller and a crossed roller bearing inner race, the roller being provided between the crossed roller bearing outer race and the crossed roller bearing inner race; and the oscillating tooth spacer is fixedly connected to the crossed roller bearing inner race via a bolt; and the oscillating tooth spacer is moved with the crossed roller bearing inner race.

In an oscillating tooth speed reducer according to an embodiment of the present application, the engagement of the oscillating tooth with the inner gear ring is a slight interference fit and is a multi-tooth engagement transmission; the number of the inner teeth of the ring gear and the number of the oscillating tooth being different by two.

In an oscillating tooth speed reducer according to an embodiment of the present application, the crossed roller bearing further includes a sealing ring for preventing grease leakage.

In an oscillating tooth speed reducer according to an embodiment of the present application, the oscillating tooth transmission mechanism further includes a centripetal ball bearing which is limited between the crossed roller bearing inner race and the oscillating tooth spacer; and the input end cam is limited in an inner bore of the centripetal ball bearing.

In an oscillating tooth speed reducer according to an embodiment of the present application, the oscillating tooth is ball-type or roller-type.

In an oscillating tooth speed reducer according to an embodiment of the present application, the oscillating tooth transmission mechanism further includes an input-shaft bearing retainer, the input-shaft bearing retainer bolted to one end of the input end cam.

In an oscillating tooth speed reducer according to an embodiment of the present application, the oscillating tooth transmission mechanism further includes a housing; and the housing, the inner gear ring, and the crossed roller bearing outer race are fixedly connected via bolts.

The design idea of the present application is to design an oscillating tooth speed reducer which can bear an axial or radial load, which retains the advantages of the transmission cycloid speed reducer, s simple in structure, and greatly improves the miniaturization and manufacturability. At the same time, a special crossed roller bearing is used, and a very good accuracy and rigidity can be achieved by pre-tightening. In addition, a tapered inner ring can also be used to arbitrarily adjust the operating clearance of the bearing, so as to not only bear the radial load, but also bear the axial load. Thus, the applicability thereof is generally improved.

Due to the adoption of the above technical features, the utility model has the following advantages and positive effects compared with the prior art.

Firstly, the present application is a transmission mechanism with a less tooth difference, having good rigidity, smooth operation, a large transmission ratio, and a small return difference, so that the speed reducer of the present application has a long service life and a low maintenance cost.

Secondly, the crossed roller bearing inner race of the present application serves as an output portion which can bear radially and axially all-round loads.

Of course, implementing any one of the specific embodiments of the contents of the present utility model does not necessarily have all the above technical effects at the same time.

### BRIEF DESCRIPTION OF THE DRAWINGS

FIG. 1 is a schematic cross-sectional view of a speed reducer of the present application;

FIG. 2 is a schematic cross-sectional view along AA of FIG. 1;

FIG. 3 is a schematic view of an oscillating tooth spacer of the present application; and

FIG. 4 is a schematic view of another oscillating tooth spacer of the present application.

### DETAILED DESCRIPTION OF THE INVENTION

In order to facilitate understanding, preferred embodiments of the present invention will be described in further detail below with reference to the accompanying drawings.

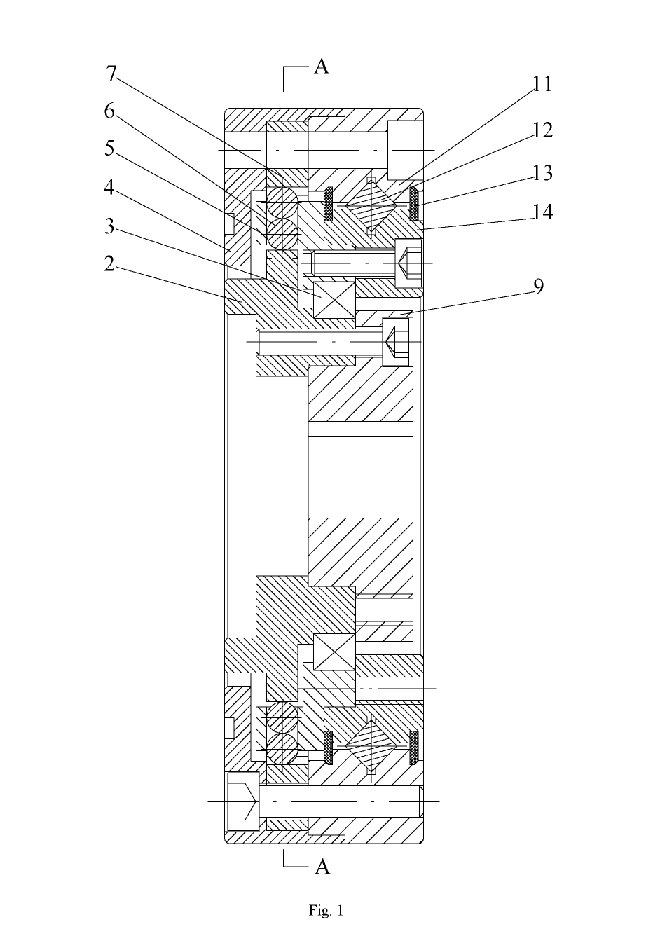

With reference to FIG. 1, a schematic cross-sectional view of a speed reducer of the present application is shown. The speed reducer of the present application is a compact device composed of two parts, namely, a crossed roller bearing which can bear radial and axial loads and an oscillating tooth transmission mechanism for a speed reduction function. An oscillating tooth transmission mechanism is used in the speed reduction part of the present application, which is equivalent to a cycloid speed reduction mechanism without a crankshaft. The engagement between the oscillating tooth and the inner gear ring adopts a slight interference fit, and is multi-tooth engagement during transmission. Meanwhile, the present application is also a transmission mechanism with a less tooth difference. Therefore, the speed reducer of the present application has good rigidity, smooth operation, a large transmission ratio and a small return difference. In the present application, the crossed roller bearing inner race is used as an output part, which can bear all-directional loads in radial and axial directions, and can be widely used in devices such as robot joint transmission, an automatic actuating mechanism and a precision machine tool.

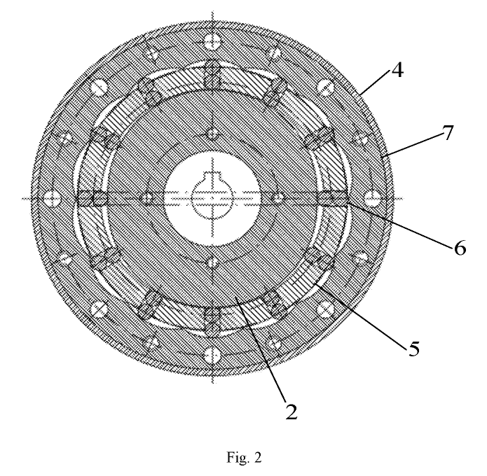

As shown in FIGS. 1 and 2, the speed reducer in the present application includes a crossed roller bearing which can bear radial and axial loads and an oscillating tooth transmission mechanism for a speed reduction function. In addition, the crossed roller bearing inner race 14 in the present application, as an output part, can bear radially and axially all-round loads. After the input rotational speed of the input end cam 2 is decelerated by the oscillating tooth transmission mechanism, and the decelerated rotational speed is transmitted from an output shaft (not shown) connected to the crossed roller bearing inner race 14.

In addition, the oscillating tooth transmission mechanism includes an input end cam 2, an oscillating tooth spacer 5, an oscillating tooth 6 provided in a plurality of uniformly arranged oscillating tooth grooves 51 of the oscillating tooth spacer 5, and an inner gear ring 7 for being engaged with the oscillating tooth 6, as shown in FIG. 2. The inner teeth of the inner gear ring 7 are cycloidal gears, and the outer edge of the inner gear ring 7 is a smooth surface. One side of the oscillating tooth 6 is rollingly connected to the input end cam 2 for an input piece of a transmission mechanism, and the other side of the oscillating tooth 6 is engaged with and connected to an inner tooth of the inner gear ring 7, and performs tangential movement with an inner tooth profile so as to drive the oscillating tooth spacer 5 to perform rotary movement. The number of the oscillating tooth grooves 51 is the number of oscillating tooth grooves required under theoretical calculation, but in practice there may be a case where the distance between adjacent the oscillating tooth grooves 51 when arranged according to the theoretical number of oscillating tooth grooves is too small to manufacture the oscillating tooth groove. The teeth can be extracted according to the requirements of the decelerating oscillating tooth transmission mechanism in the present application, namely, the number of the oscillating tooth grooves 51 is uniformly reduced so as to satisfy the manufacturability of the oscillating tooth spacer 5.

In FIG. 1, the crossed roller bearing includes a crossed roller bearing outer race 11, a roller 12 and a crossed roller bearing inner race 14, and the crossed roller bearing outer race 11 and the crossed roller bearing inner race 14 are provided with uniformly distributed threaded holes and bolt through holes for connecting other parts of the present application. The rollers 12 are provided between the outer crossed roller bearing ring 11 and the crossed roller bearing inner race 14 in such a manner that a roller accommodating groove is provided on the outer surface of the crossed roller bearing inner race 14, and a roller accommodating groove is correspondingly provided on the outer surface of the crossed roller bearing outer race 11. During assembly, the roller 12 is placed in the two correspondingly provided and enclosed roller accommodating grooves. As shown in FIG. 1, there is a gap between the two correspondingly provided and enclosed roller accommodating grooves. The oscillating tooth spacer 5 is fixedly connected to the crossed roller bearing inner race 14 via a bolt. That is to say, the oscillating tooth spacer 5 and the crossed roller bearing inner race 14 are assembled into one. In this design, when the oscillating tooth spacer 5 performs a rotary motion, the crossed roller bearing inner race 14 moves therewith at the same time, and the motion of the crossed roller bearing inner race 14 belongs to a speed output after deceleration.

In addition, the engagement of the oscillating tooth 6 and the inner gear ring 7 is a slight interference fit and is a multi-tooth meshing transmission. The number of the inner teeth of the inner gear ring 7 and the number of the oscillating tooth 6 are different by two. In the embodiment of the present application, the number of the inner teeth of the inner gear ring 7 is 14, and the number of the oscillating tooth 6 is 12, but these cannot be used to limit the present application, and the number of teeth meeting the deceleration requirement should be fall in the scope of protection of the present application. The present application is also a transmission mechanism with a less tooth difference. Therefore, the present application has good rigidity, smooth operation, a large transmission ratio and a small return difference. In addition, the number of teeth of the inner gear ring 7 may be two less than the number of teeth of the oscillating tooth 6 due to the particularity of the oscillating tooth transmission.

In FIG. 1, the crossed roller bearing further includes sealing rings 13. In the embodiment of the present application, the number of the sealing rings 13 is two, and the sealing rings 13 are respectively provided on two sides of the gap existing between the two roller accommodating grooves. The purpose of the sealing ring 13 is to prevent leakage of grease for lubrication.

In FIG. 1, the oscillating tooth transmission mechanism further includes a centripetal ball bearing 3, and the centripetal ball bearing 3 is positionally limited between the crossed roller bearing inner race 14 and the oscillating tooth spacer 5. The input end cam 2 is limitedly provided in an inner hole of the centripetal ball bearing 3. The centripetal ball bearing 3 is mounted between the crossed roller bearing inner race 14 and the oscillating tooth spacer 5, and can limit the axial position of the centripetal ball bearing 3. The input end cam 2 is positioned and mounted in the centripetal ball bearing 3 through the inner bore of the centripetal ball bearing 3, i.e., after assembly, the input end cam 2 can rotate in the centripetal ball bearing 3, and the crossed roller bearing inner race 14 and the oscillating tooth spacer 5 can rotate on the centripetal ball bearing 3.

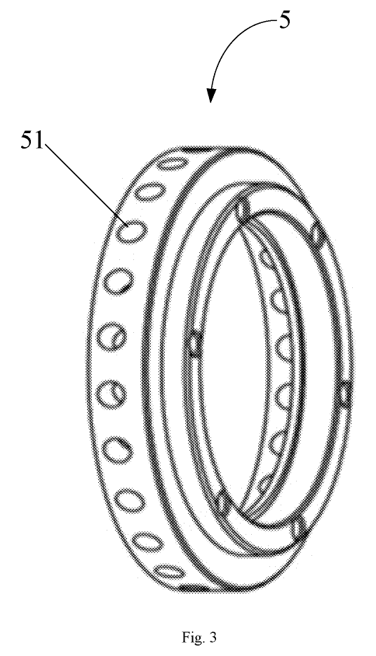

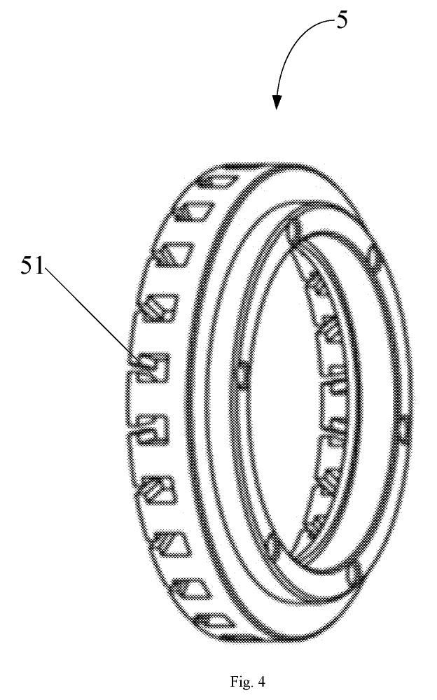

With reference to FIGS. 3 and 4, the oscillating tooth spacer of the present application is schematically illustrated. The oscillating tooth 6 is a ball type or a roller. When the oscillating tooth 6 is a ball type, the oscillating tooth spacer 5 is as shown in FIG. 3. When the oscillating tooth 6 is a roller, the oscillating tooth spacer 5 is as shown in FIG. 4. The difference between FIGS. 3 and 4 lies in that the shapes of the oscillating tooth grooves 51 for assembling the oscillating tooth 6 are different. The oscillating tooth 6 perform a radial reciprocating motion driven by the input end cam 2, and the number of layers of the oscillating tooth 6 can be provided in one or more layers according to the requirements of the wall thickness of the oscillating tooth spacer 5, as shown in FIGS. 3 and 4. The number of layers of the oscillating tooth 6 in the embodiment of the present application is one layer, and the number of the oscillating tooth 6 in each layer is two.

As shown in FIG. 1, the oscillating tooth transmission mechanism further includes an input-shaft bearing retainer 9, wherein the input-shaft bearing retainer 9 is connected to one end of the input end cam 2 via a bolt. During assembly, the input end cam 2 is located via the inner hole of the centripetal ball bearing 3 and is mounted in the centripetal ball bearing 3, and one end face is fixed by the input-shaft bearing retainer 9, and is fastened by the bolt. After assembly, the input end cam 2 can smoothly rotate in the centripetal ball bearing 3. The oscillating tooth transmission mechanism further includes a housing 4. The housing 4, the inner gear ring 7 and the crossed roller bearing outer race 11 are fixedly connected by means of bolts. According to the connection method, the housing 4 is fitted with the inner gear ring 7 and then mounted on the crossed roller bearing outer race 11, and then fixed using a bolt. As mentioned above, the crossed roller bearing outer race 11 is provided with uniformly distributed bolt through holes for connecting other parts of the present application, namely, the bolts connects the housing 4, the inner gear ring 7 and the crossed roller bearing outer race 11 via the bolt through holes.

The transmission in the present application is a double-shock oscillating tooth planetary reduction mechanism. The input end cam 2 is equivalent to a sun gear of a planetary reduction gear. The profile of the input end cam 2 is an ellipse. When the input end cam 2 rotates around the center, the oscillating tooth 6 arranged uniformly in a radial direction in an oscillating tooth groove 51 of the oscillating tooth spacer 5 will slide radially back and forth. That is to say, the oscillating tooth 6 and the oscillating tooth groove 51 are in sliding fit. The ring gear 7 is fixedly mounted on the housing 4, and the tooth profile of the internal teeth of the ring gear 7 is arranged according to the moving track of the section of the oscillating tooth 6. The number of internal teeth forms a two-tooth difference with the theoretical number of the oscillating tooth 6. Thus, after each half revolution of the input end cam 2, the oscillating tooth 6 slides back and forth in the radial direction, and the oscillating tooth 6 also moves tangentially to the internal tooth profile by one tooth profile. The oscillating tooth 6 also move tangentially due to the action of the tangential component of force, and this tangential movement simultaneously brings the oscillating tooth spacer 5 into a rotational movement, which is a decelerating movement of the two-tooth difference.

Next, the reduction ratio, i=-(z2-z1)/z1 in the present application (where z1 is the number of theoretical oscillating tooth grooves 51, and z2 is the tooth number of ring gear; in general, z2-z1 = 2; however, due to the particularity of oscillating tooth transmission, the tooth number of inner gear ring can also be two less than that of theoretical oscillating tooth grooves 51, i.e., z2-z1 =-2). Since the present application is directly input by the input end cam 2, no eccentric shaft is needed, and the motion track of the oscillating tooth transmission mechanism served as the speed reduction mechanism is equivalent to the cycloidal speed reducer, the present application is also referred to as a crankshaft-free cycloidal speed reducer. Due to the elimination of the crank mechanism, the present application is smaller in volume and lighter in weight than the cycloidal speed reducer in the prior art.

In summary, the profile of the input end cam 2 is a double eccentric semi-circular arc, and the two semi-circular arcs are connected by a straight line transition. The tooth form of the inner gear ring 7 is a hypocycloidal tooth form, and the tooth form profile thereof can be consistent with the track of the motion section of the oscillating tooth 6, so as to ensure the continuity of the movement of the oscillating tooth transmission mechanism for realizing the speed reduction function. The output is carried by the crossed roller bearing which is dedicated and can realize a load in all directions of a radial direction and an axial direction. The deceleration part is realized by an oscillating tooth transmission mechanism. According to the implementation method, the input end cam 2 serves as a driving part, the inner gear ring 7 is fixed, and the oscillating tooth 6 and the oscillating tooth spacer 5 serve as a deceleration output end. When the input end cam 2 rotates about the center line, the oscillating tooth spacer 5 will produce a decelerated rotational output in accordance with the established gear ratio.

It should be noted that in the description of the embodiments of the present application, the orientation or positional relationship indicated by terms such as "front, back", "left, right", "up, down", and the like is based on the orientation or positional relationship shown in the drawings, and is only for the convenience of describing the present application and simplifying the description, rather than indicating or implying that the referred device or element must have a specific orientation, be constructed and operated in a specific orientation, and thus should not be construed as limiting the present application. The terms "mounted", "connecting", and "connected" are to be construed broadly, e.g., either fixedly attached, detachably attached, or integrally attached. It may be a direct connection or indirect connection by an intermediary. It may be a communication between two elements. The specific meaning of the above terms in the present application will be understood to those skilled in the art on a case-by-case basis.

Due to the adoption of the above technical features, the utility model has the following advantages and positive effects compared with the prior art.

Firstly, the present application is a transmission mechanism with a less tooth difference, having good rigidity, smooth operation, a large transmission ratio, and a small return difference, so that the speed reducer of the present application has a long service life and a low maintenance cost.

Secondly, the crossed roller bearing inner race of the present application serves as an output portion which can bear radially and axially all-round loads.

The above-mentioned disclosure is merely preferred embodiments of the present utility model, and is not intended to limit the present utility model itself. Any equivalent changes and modifications made by those skilled in the art without departing from the spirit and scope of the present utility model shall fall within the scope of the present utility model.

1. An oscillating tooth speed reducer, comprising a crossed roller bearing to bear radial and axial loads and an oscillating tooth transmission mechanism to perform a speed-reducing function;
wherein the oscillating tooth transmission mechanism comprises an input end cam, an oscillating tooth spacer, an oscillating tooth provided in a plurality of uniformly arranged oscillating tooth grooves of the oscillating tooth spacer and an inner gear ring for being engaged with the oscillating tooth; one side of the oscillating tooth is rollingly connected to an input piece of the input end cam for the transmission mechanism; the other side of the oscillating tooth is engaged with the inner gear ring for performing a tangential motion with the internal gear profile to drive the oscillating tooth spacer to perform rotary motion;
the crossed roller bearing comprises a crossed roller bearing outer race, a roller and a crossed roller bearing inner race; the roller is provided between the crossed roller bearing outer race and the crossed roller bearing inner race; the oscillating tooth spacer is fixedly connected to the crossed roller bearing inner race via a bolt; and the oscillating tooth spacer is moved in conjunction with the crossed roller bearing inner race.

2. The oscillating tooth speed reducer according to claim 1, wherein the engagement of the oscillating tooth with the inner gear ring is a slight interference fit and is a multi-tooth engagement transmission; and the number of the inner teeth of the inner gear ring and the number of the teeth of the oscillating tooth being different by two.

3. The oscillating tooth speed reducer according to claim 2, wherein the crossed roller bearing further comprises a sealing ring for preventing grease leakage.

4. The oscillating tooth speed reducer according to claim 3, wherein the oscillating tooth transmission mechanism further comprises a centripetal ball bearing which is limited between the crossed roller bearing inner race and the oscillating tooth spacer; and the input end cam is limited in an inner bore of the centripetal ball bearing.

5. The oscillating tooth speed reducer according to claim 4, wherein the oscillating tooth is ball-type or roller-type.

6. The oscillating tooth speed reducer according to claim 5, wherein the oscillating tooth transmission mechanism further comprises an input-shaft bearing retainer, the input-shaft bearing retainer bolted to one end of the input end cam.

7. The oscillating tooth speed reducer according to claim 6, wherein the oscillating tooth transmission mechanism further comprises a housing; and the housing, the inner gear ring, and the crossed roller bearing outer race are fixedly connected via bolts.
